(19) United States
(12) Patent Application Publication
(10) Pub. No.: US 2019/0189020 A1
(43) Pub. Date: Jun. 20, 2019

(54) ARRANGEMENTS FOR DELIVERY OF A TAILORED EDUCATIONAL EXPERIENCE

(71) Applicants: Saranjeet Singh Punia, Seguin, TX (US); Sourav Nandy, Austin, TX (US); Sanjay Dubey, Austin, TX (US); Adrian Resendez, Austin, TX (US)

(72) Inventors: Saranjeet Singh Punia, Seguin, TX (US); Sourav Nandy, Austin, TX (US); Sanjay Dubey, Austin, TX (US); Adrian Resendez, Austin, TX (US)

(21) Appl. No.: 15/841,847

(22) Filed: Dec. 14, 2017

(51) Int. Cl. G09B 5/12; G06F 17/30; G06F 15/18

(52) U.S. Cl. CPC G09B 5/12; G06F 15/18; G06F 17/3053; G06F 17/30035

(57) ABSTRACT

Arrangements for delivering educational content to students are disclosed. The arrangements can include a method that includes registering a student by interviewing the student and storing information associated with the student's educational history and generating parameters and variables related to the student's prior educational experiences. A query for educational content can be received from the student, with student selectable filters and tailored search criteria for educational materials can be generated based on the variables, and parameters associated with the student and the received query. The results of the search can be transmitted to a search engine and tailored search results can be received and displayed to the student. The system can be self-learning where after use by students, student specific profiles and user models can be generated which can increase the number of user parameters and variables and supplementary information in the student's profile and or model.

### FIELD OF INVENTION

The present disclosure is related to the field of online educational services and more particularly, to the field of administration of online educational services and a framework for administrating, managing and providing tailored educational services.

### BACKGROUND

Anyone who searches the World Wide Web or Internet for educational content can appreciate that current online educational systems and their frameworks have many shortcomings. A typical educational website utilizes a web search engine that will search for information on the World Wide Web and then present a list of search results often referred to as search engine results pages (SERPs). The information displayed is typically a mix of text and images and links to various web pages. As far as can be determined personalization of educational material delivered by current educational websites only includes the process of gathering and storing general information about website users, i.e. subject matter, educational level etc., and delivering content based on such information.

Some search engines also mine data available in databases or open directories. Unlike web directories, which are maintained only by human editors, search engines also maintain real-time information by running an algorithm on a web crawler. Web search engines get their information by web crawling from site to site to gather information and collect index and store metadata often in the form of HTML meta tags. The indexing process can associate words and other definable tokens found on web pages to their domain names and HTML-based fields to allow the search engine to efficiently find information based on key words in a user query. Typically, when a user enters a query into a search engine, the engine will parse a few keywords where sites containing those keywords can be instantly obtained from a stored index of sites. After links to the search results are received by the search engine, the search engine must determine an order of importance based on relevance of the link according to information in the indexes, and but the main processing load of the search engine is in generating the web pages based on the retrieved and sorted list.

Beyond simple keyword lookups, major search engines offer their own graphical user interface or GUI or command-driven operators and search parameters that are intended to refine which search results are returned. Some search engines allow the user to better tailor their search; for example, Google's search engine via selection of the “Show search tools” allows a user to filter retrieved content by a date code by selecting or clicking on the leftmost column of the initial search results page, and then selecting the desired date range (i.e. filtering what is) to be displayed.

There are various online educational platforms that attempt to do a better job of educating students than a standard browser, and they range from accredited non-profit online universities, to for profit online educational services, to websites that specialize in publishing scholarly articles, to encyclopedia type sites such as Wikipedia and everywhere in between. Many such online platforms operate in a monologue format or shallow teaching model wherein the platform simply provides educational content in the form of definitions, explanations and tutorials. However, often this content is not current, or accurate and such an interaction and content does not promote or allow for cognitive learning. It is well known that a deeper processing or learning strategy that focuses on meanings, comprehension, relation to other concepts, difference in concepts, relating concepts to personal experience, how to apply a concept and visual learning aids is much more efficient and effective way for students to learn.

Traditional personalized educational recommendation approaches can be divided into two major categories: content-based filtering and collaborative filtering. In content based filtering, a profile is generated for a user based on content descriptions of the content items previously rated by the user. However, one major drawback to this approach is the limited capability of current systems to recommend content items that are different than those previously rated by users.

Collaborative filtering, which is one of the most successful and widely used techniques, analyzes users' ratings to recognize commonalities and recommend items by leveraging one user's preferences against other users with similar interests and tastes. However, a typical portal website aims to retrieve the most current or latest information or retrieve information based on trending topics.

With the maturation of communication devices and the Internet, new teaching strategies and techniques have evolved, including various online classes, the utilization of social media to connect students and educators, the delivery of digital content and a host of other solutions which are currently available. Unfortunately, and as stated above all current educational platforms and solutions have turned out to operate as some form of monologue or shallow learning routine. The effectiveness of such monologue solutions is less than perfect because such monologue solutions do not consider a student's learning capacity, prior learning experiences and do not quantify a user's understanding of the content provided. For example, often a student in an online learning/testing session will often just look up an answer on the World Wide Web and enter an answer which does not invoke cognitive learning and such a process does not help the student imbibe the concept, and may not even promote learning via rote memory. In such a situation, no intrinsic learning occurs and students who engage in such behavior often have difficulties in solving problems efficiently later in life.

There is a need for an online platform that can be effective in a global environment to impart tailored knowledge to students based on deep or cognitive teaching theories and the student's historical educational background. It can be appreciated that, providing a learning experience based on a student's background is not a straight forward or intuitive process. For example, the interactive manner by which to engage the student and provide the student with choices and interactive content is not intuitive. It can be appreciated that knowledge sharing between educators, students, parents, and institutions from different cultures currently has major shortcomings and is by far less than perfect. It would be beneficial to have a paperless construction project administration and management system that could set up, monitor, manage and administrate a construction process saving time, money, resources, and the environment.

### BRIEF DESCRIPTION OF THE DRAWINGS

Aspects of the disclosed embodiments will become apparent upon reading the following detailed description and upon reference to the accompanying drawings in which, like references may indicate similar elements:

FIG. 1 is a flow diagram showing various functions and features that can be utilized to facilitate the administration and management of an online educational service that provides tailored personalized content;

FIG. 2 is a block diagram of a system that could be utilized to implement the functions and features of the system disclosed herein;

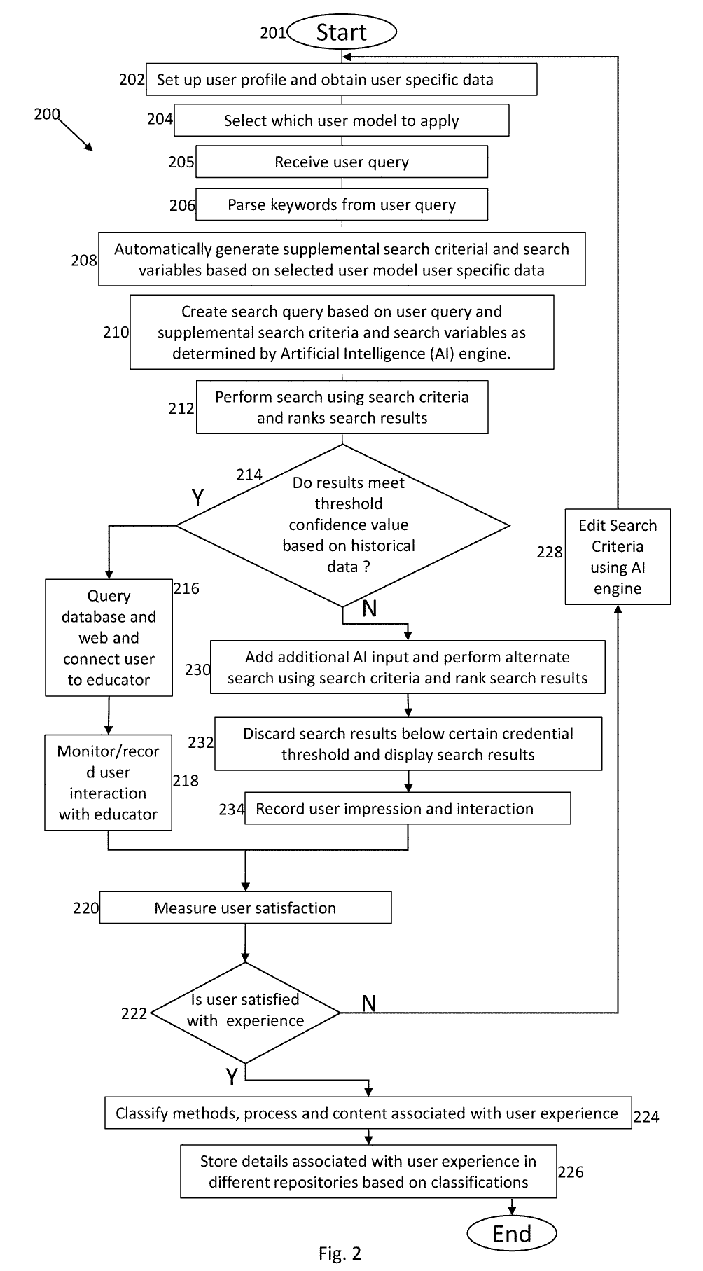

FIG. 3 is a block diagram of various process modules that could be utilized to implement the disclosed system;

FIG. 4 is block diagram showing an alternate version of modules and application programing interfaces that could be utilized to implement the disclosed system; and

FIG. 5 depicts a graphical user interface that could be utilized to interface with a student.

### SUMMARY OF INVENTION

In some embodiments, a computer program product is disclosed that includes a computer readable storage medium including instructions that, when executed by a processor cause the processor to store in a relational database, queries associated with requests for educational materials. Arrangements for delivering educational content to students are disclosed. The arrangements can include a method that includes registering a student by interviewing the student and storing information associated with the student's educational history and generating parameters and variables related to the student's prior educational experiences.

A query for educational content can be received from the student, with student selectable filters and tailored search criteria for educational materials can be generated based on the variables, and parameters associated with the student and the received query. The results of the search can be transmitted via a search engine and tailored search results can be received and displayed to the student. The system can be self-learning where after use by students, student specific profiles are continually updated by information learned about the student and the student's learning experiences.

In some embodiments a computer program product is disclosed that can facilitate delivering educational content to a student. The product can include a computer readable storage medium that has instructions that, when executed by a processor cause the processor to collect information associated with a student, where the information has parameters associated with biographical information of student and store such information. The processor can also receive a query from the student for educational materials, along with student selectable filter setting and generate student centric search criteria for educational information based on the query and the collected information by generating weighted search vectors associated with the search query and the collected information.

Operating on the instructions the processor can facilitate the transmission of the student centric search criteria to a search engine and receive and display a first set of search results. In some embodiments the processor operating in response to instructions can monitor user interactions and generate student user models based on the collected information, and then monitored user interactions and a second query from the student to produce improved second search results.

In sonic embodiments include monitoring a student's interaction with the system and content to determine a student satisfaction metric. In other embodiments the processor can facilitate the learning of student reference based on the monitoring and the operation of an artificial intelligence and/or fuzzy logic engine. A method for delivering educational content which collects information related to a student on a cloud based server and associates the information with a student's educational history and behavior based on the student's past interactions with content displayed on a browser.

In addition, the method can segment and classify the collected data and generate a plurality of student-user models and based on receiving a query from the student, generate a tailored search criterion for educational materials based on the variables, and parameters associated with the student and the received query. The system can then transmit the tailored search criteria to a search engine; and receive and display a first set of search results in response to the tailored query. The system can also develop or generate a student specific user model based on the user parameters and variables and supplementary information acquired from the user parameters and variables.

The parameters can include a student defined search filter such as a content by subject filter, an expertise level search filter, and educator search filter, a people with biographically similar backgrounds search filter, educators with biographically similar background search filter, an ask an educator filter, a school search filter, a class search filter, notes, and an evaluation, and feedback filter to name a few. The system can also query the student about the student's impression from the content and/or monitor a student's interactions with the displayed first search results to determine a student satisfaction metric.

### DETAILED DESCRIPTION OF EMBODIMENTS

The following is a detailed description of embodiments of the disclosure depicted in the accompanying drawings. The embodiments are in such detail as to clearly communicate the disclosure. However, the amount of detail offered i s not intended to limit the anticipated variations of embodiments. The description that follows is for purposes of explanation and not limitation, specific details are set forth such as particular structures, architectures, interfaces, techniques, etc. to provide a thorough understanding of the various aspects of the invention. However, it will be apparent to those skilled in the art having the benefit of the present disclosure that the various aspects of the disclosure may be practiced in versions that depart from these specific details. In certain instances, descriptions of known apparatuses, systems and methods are omitted so as not to obscure the explanation, teaching and description of the claimed embodiment with unnecessary detail. The teachings herein are intended to cover all modifications, equivalents, and alternatives falling within the spirit and scope of the present disclosure as defined by the appended claims. In general, the delivery of any personalized educational content by educational type websites involves a process of gathering and storing general information about website users, managing learning content assets, analyzing current user interactions, and, based on this delivering what is considered the “best” content to a user.

The teachings herein disclose many improvements to all phases of delivering educational content. The disclosed embodiments disclose how to in increase efficiency, reduce costs, decrease liabilities, and improve the quality at each stage of the educational process. The disclosed administration and management systems and methods allows educator's cost-effective measures for delivering tailored educational content. It can be appreciated that the disclosed embodiments greatly reduce the cost and resources required to provide a student with deep learning experiences and the disclosed embodiments make it much more efficient to manage all phases of the educational process.

There are a few online systems that support certain phases of the educational process however they lack the functions and features required to make effective and efficient educational tools that allow for cradle-to grave administration and management of the educational process. Accordingly, the disclosed embodiments provide for effective and efficient administration and management for phases of very diverse educational subject matter across diverse cultures.

The platform disclosed herein provides global interactive educational offerings with a learning process that solves numerous shortcomings of current frameworks such as cultural barriers that currently exist in online educational services. Such barriers are traversed by understanding a user or student's profile and focusing and providing an interactive learning process based on what is known about the user. Such a focused learning process can utilize artificial intelligence, and/or fuzzy logic, notes repository from previous instances/operations, metadata associated with collaborative projects, a data base of vetted educators and/or teachers, video, audio, and textual content, a social media interface with groups and messaging features and other frameworks and features that promote and provide an efficient, effective, comprehensive and easy to use learning framework.

There have been many different methods and techniques utilized across the world to teach students since ancient times. Most of these educational techniques involved elements of cultural affinity. Cultural affinity in an educational context can be described for example as a student's organic liking or preference for a particular type of content, content format, teaching style, teaching method etc. Such a student's preference often becomes ingrained in the student from the particular teaching culture that student has previously experienced such as the culture within the educational system and fabric of the society that the student has come to know. One of the problems the disclosed system efficiently and effectively solves is systematic difference in educational environments between multiple cultures which often hinders mutual understanding or relations in a teaching environment. Such educational cultural differences can include the educational formats, teaching aids, such as mnemonics, languages, delivery mechanisms, and customs of the respective cultures. Thus, student incomprehension of the educational content is very common when a student from one culture is placed into a different educational culture (i.e. where the student has different educational experiences due to different teaching methods that are currently being presented to the student).

The disclosed invention can be described as a hybrid online educational platform which provides a professional framework supported by networking levers that are integrated with a social media platform, wherein interactive sessions, note sharing, project collaboration, content creation, group discussions, messaging, notifications, and fuzzy logic/artificial intelligence all work together to provide an enjoyable learning environment to students while enabling them to achieve cognitive learning. The disclosed system also enables educators to interact with each other to address shortcomings of current online educational offerings. For example, such shortcomings include cultural educational gaps that exist between educators, students and teaching materials, Educational cultural gaps It can be appreciated that each culture utilizes different teaching methods and methodologies including different memorization tools or teaching acronyms for a particular subject or technology. It can be appreciated that we now live in a global economy, but global educational systems have not kept pace.

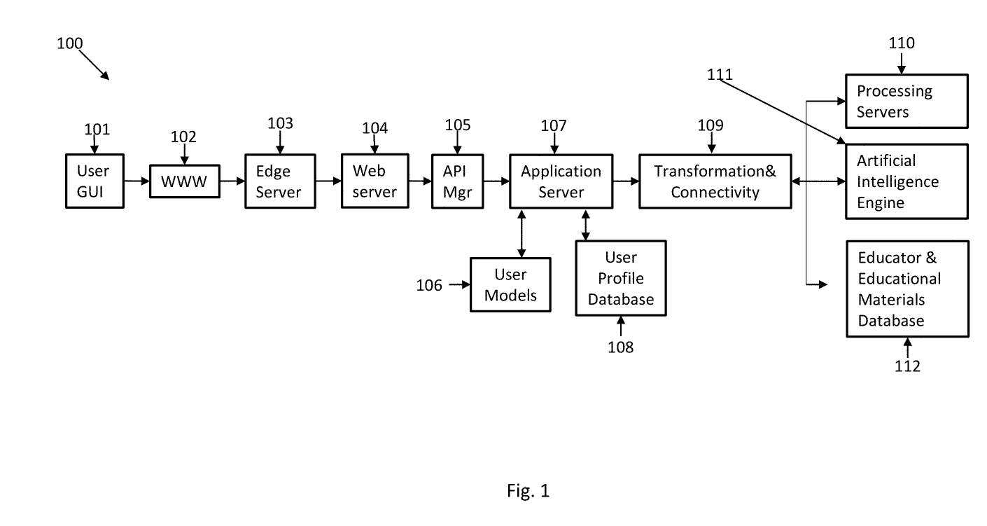

Referring to FIG. 1 a basic communication flow diagram 100 of the disclosed system and method is depicted. A user operating a graphical user interface 101 can access the system's webserver 104 via the World Wide Web, (aka., the Internet) 102, via an edge server 103. The system can also include an application programming interface (API) manager 105 that can manage system APIs, enforce usage policies of the API's, controlling access to various resources, nurturing the user/student community, collecting and analyzing usage statistics, and reporting on system performance among other tasks. For example, the API manager can control the operation of application server 107. Application server 107 can process a student's request and facilitate access to various processes conducted by software modules of the system. For example, based on what is known about the user and as stored in user profile database 108, application server 107 can generate, maintain and continuously improve user models 106 as they apply to each student. Application server 107 can process various inputs and information to generate tailored learning criteria along with a tailored learning process for a student, based on a user model that is determined by the system to be a best fit given the current student's request and circumstances.

Based on a selected user model the application server 107 can utilize many criteria and variables to generate a lesson plan for each student. Such a lesson plan can include the selection of educators, the steps and order of steps for each student's tailored educational process, the selection of customized educational materials, the way to deliver such content, i.e. face to face video communication with a vetted educator, textual materials and testing, online chats, the inclusion of the student in various social media environment, etc. Based on the task requested, application server 107 can interface transformation and connectivity module 109 which can manage communication between processing servers 110, artificial intelligence engine 111, and educator and educational materials database.

Using the disclosed interactive methods, combined with social media and fuzzy logic/artificial intelligence, the systems and methods of the current disclosure provide a system with a holistic approach that imparts knowledge and learning at a very tailored, customized and personalized level. The disclosed system and method can effectively be breaking cultural barriers by bridging cultural knowledge gaps between educators and students globally. In addition, the disclosed system promotes a learning environment having a capacity level that encompasses a holistic environment where students can learn and assimilate concepts within the comfortable cultural environment the student desires.

Flow chart 200 is a flow diagram that illustrates how certain elements of the present disclosure can be implemented. The process can start at block 201 and proceed to block 202 where a user account, profile and model can be set up and user specific data can be acquired. User specific data can consist of data that can be utilized to identify the user to provide an internal representation of the user such that the system can understand the characteristic and preferences of the user. Such data can be utilized to provide a more pleasurable user experience. Information about users can be gathered in several ways including registering a user, then asking the user for specific facts about themselves as the user interacts with the system's front end graphical user interface. The user profile graphical user interface can include menu driven questions, IQ tests, and interactive Q & A interviews, tailored menu driven questionnaires, an auto populate option where data is auto entered from scanning one or more of a user's social media account.

In some embodiments, the user signup process can be similar to a college enrollment application where various data is acquired form the prospective student. It can also be appreciated that an extensive variety of data can be obtained about the user and certain user data can be very important in allowing the method and system to operate most efficiently and accordingly provide a better user experience or better results for a user. For example, such data can comprise of a user's age, sex, race, native language, birth country, intelligence Quotient (IQ), education level, educational interest, educational method preference, languages spoken etc. When registering users, the system can request specific facts about the user regarding the user's needs, goals, desires, likes and dislikes and their past experiences. The system can provide the user with the ability to change or alter their original input at a later date. For example, if a user will typically advance from beginner or novice to advanced beginner to competent to proficient to expert status as the students build their foundation in a particular topic.

Institutions as demonstrated through citation networks. Creation of a highly detailed, dynamic, global model and map of science instructors often specify whether articles consulted are to be from popular or scholarly publications (the former usually referred to as magazines, the latter as journals). Although popular sources are not without merit and may also contain wells considered writing, the purpose of distinguishing between these types of works is to determine their degree of authority and depth of research on a given topic, and thereby their intrinsic academic value.

As will be described below, in addition the system can learn a user's preferences by observing and interpreting their interactions with the system. It is one goal of the system to work towards what the learning desires of the user are and how best to serve those desires. The system can implement a hybrid of various known user models with a weighting system that weights the influence of various user models on system operation. As illustrated by block 204, based on the amount of information acquired from the user, it can be determined what type of user model the system will implement. In accordance with some embodiments of the disclosure, user specific data can be obtained in a variety of ways. For example, in some embodiments user modeling can be implemented or the building up of an understanding of the user's background and needs, and the system can continually modify a conceptual understanding of the user based on user interactions.

The disclosed user modeling process can customize and adapt the systems and content provided to a user's specific needs. The system can model the user's skills, declarative knowledge, and previous or native teaching experiences. In some embodiments user testing can be implemented however, user models and user modeling can often be a more efficient alternative. The user profile can include personal information such as users' names, age, interests, skills, education level, knowledge, goals, plans, preferences, dislikes, data about user behavior, interactions with the system etc. Many different design patterns could be utilized for user models, including a hybrid or mixture of different models.

The user models could be dynamic user models where the user profile is continually updated based on what the user accomplished and how they rate their experiences. Thus, each user's model can be continually updated based on a user's perceived interests, their learning progress or interactions with the system. Thus, each user model can be updated based on the current needs and goals of each user.

User models could also be stereotype user models which are based generally on a user's native language, education and demographic information. Based on user information and statistics, a user experience can be tailored based on stereotypes associated with this user data. The application therefore can make assumptions about a user even though there might be no data available to the system on a particular topic or data point, because there is data and studies that relate certain data such as personal attributes, educational level, native language, demographics etc., to other users that show users with similar backgrounds desire a particular educational and/or learning experience and the system can deliver such an experience based at least in part on stereotypes associated with user profile data or a user model associated with a student. A stereotype modeling allows the system to predict an impression that a user would prefer even if the system has minimal information about the user.

In some embodiments the system can utilize a highly adaptive user model which operates to individually represent a user and therefore has a very dynamic adaptivity which generally can be utilized to find tailored and/or specific solution for each user. It can be appreciated that generally the more data the system has on a particular user the better the user experience provided by the disclosed system. Thus, for users that the system cannot acquire a minimum threshold amount of information the system may implement more of a stereotype based user model.

Referring to block 205 the system can prompt the user and the user can enter a query for information of knowledge and referring to block 206, the system can parse keywords from the user query. Referring to block 208 the system can generate supplemental search criteria and search variables based on the selected user model and user profile data. Supplemental search criteria can include linking articles utilizing keyword, educator, bibliographic, citation, co-citation topical, co-authorship and co-keyword linking and determine how content relates to other content.

Mathematical functions including multidimensional scaling and weighting can be utilized to determine or measure the similarities among the different linking networks to modify a student's search criteria. In addition, a hybrid or heterogeneous search term supplementer can be utilized to learn what modifiers or supplements to search criteria can improve search results as they apply to social, cognitive, and geographic data related to students.

Referring to block 210 the system can generate search criteria based on the user query, the supplemental search criteria and supplemental search variables such as operators as supplied by an Artificial Intelligence engine (Al). Parameters and criteria of the tailored search can be generated based on the user's request for knowledge, the type of user profile selected by the system and data in the user's profile. The tailored search can include supplemental and auxiliary search variables that are generated by the system based on user specific data and the user model selected by the system.

Referring to block 212 a search can be conducted via the internet world wide web and the search results can be vetted and ranked using an AI engine. For example, the results can be vetted and evaluated based on historical user data associated with previous user experiences. Referring to block 214 the system can utilize various criteria to determine if the search results meet a threshold confidence value based on numerous criteria.

Referring to block 216 a database of educators, educational content uploaded by he educator and other relate educational sources can be accessed, and the search results can include a list of educators or educational systems that have a high likelihood of providing an acceptable user experience. Referring to block 218 the user interaction with the educator or educational materials can be monitored and relative data can be recorded to establish a user impression of the returned search criteria and the users' experience with the system generally. Such user behavior data derived from interactions with the user can be stored in the user profile and utilized to supplement the user provided information. For example, user interaction data can be gathered regarding the way a user chooses to accomplish one or more tasks, a combination of things a user selects or takes interest in, and other observations of user activities which allows the system to make inferences about the user. Such feedback to the system allows the system to dynamically learn from observing these interactions. Different machine learning algorithms may be used to accomplish this task.

Referring to block 220 user satisfaction can be measured or quantified. One such measurement can be to detect indications that the student experienced a deep or cognitive learning experience. Such a metric can be measured in a number of different ways such as acquiring answers to test questions or some other evaluation method, including student reactions, satisfaction ratings, observations, of some other form or method of assessment. The user satisfaction metric can be facilitated with, or work in connection with a rewards type program where the student is given redeemable reward points based on the student's participation in the student satisfaction feedback portion of the system or process. User satisfaction can also be measured based on cognitive learning theory principals. It is agreed by many that in order for a student to adequately learn, the student must develop at least some problem-solving skill in the subject matter, have some memory retention, develop at least some thinking skills and/or have a perception of what was learned material. The disclosed system can provide a quality learning experience by delivering audio visual content in a format that promotes the above mentioned deep learning experience based on information stored by the system for the subject user. For example, such a determination can be made based on information on the student's, educational history, cultural background, preferred learning methods and desires and thus the system can deliver personalized content to the student.

Referring back to block 214, if the search results do not meet a threshold value based on a confidence level, the process can proceed to block 230 where the system can utilize the Al engine to modify the user model, further define data in the user profile, modify the search criteria and search variables. The data acquired on the user can be utilized to modify which user model is implemented in the process and the system can query and accept additional user input or additional user requests.

Thus, at block 230 a user's model can be altered, and the system can implement a hybrid user model approach. In addition, the system can also ask for explicit feedback which could be utilized to adjust the user model implementation. The system can also query the user regarding how the search could be improved and then the system could use such data to alter the user model based on this direct user input and further by an adaptive learning process. During every step of the process user interactions can be monitored and recorded and important information about the user can be derived from such observations and user input, and the combination thereof can be used to automatically adjust the user's model.

Thus, the first time through the process the users' experience will likely be the least pleasurable user experience because initially the system will be operating on a minimum of quickly collected user data, (at the option of the user) based on the initial user profile and thus the system will lack the ability to automatically adapt based on previous user experiences which can be better tailored to a users' interests. Thus, the success of initial user experience with the system can depend on the users' desire and ability to give information and often users don't amend or edit data in their profile once the registration process is finished.

Referring to block 232 the search results returned can be evaluated and if indicators suggest that the results are below a certain threshold the results can be discarded and the results above the criteria can be displayed to the user. As shown in block 234, user impressions can be recorded based on user interactions. Referring back to block 220, after user satisfaction is measured, the method can proceed to block 222 where based on a predetermined threshold, it can be determined if the user is satisfied with their learning experience. If it can be determined that the user had a satisfying experience the process proceeds to block 224 where details of the user experience and details of the process utilized to engage and serve the user and other data associated with the user experience can be classified as to the type of data and/or model utilized, and search criteria and type of media associated with the experience etc. can be organized and or classified.

Referring to block 226 the details associated with user experience can be stored in different repositories based on associated classifications into a data base. Referring to block 228 the search criteria can be edited based on input from the Artificial intelligence engine. If at block 222 it is determined that the user experience was not satisfactory, additional processing can be performed and the search criteria can be modified as illustrated by block 228. As illustrated the artificial intelligence module can modify the user model, ranking criteria, search variable and search criteria such that a different and improved search result can be achieved. Since the system continuously adapts and improves user profiles by recording and analyzing multiple user experiences, such data can be utilized for new users by cross pollination algorithms. Adaptive changes in the system based on learning a users' preferences by interpreting a user's behavior can provide improved user experiences.

The system can continually collect user data and then make a threshold decision that enough data has been collected such that the system can effectively begin predicting a user's desires and needs with the required accuracy to provide an improved user experience which the system could not have done without the user data. Therefore, it may take a certain amount of data acquisition time before the system can provide the user with benefits from adaptive changes to the user profile and the user model. Over time, such automatically learned adjustments to user profiles and models can provide very accurate system adaptivity. It can be appreciated that the user model selection module can adjust the user models to reach improved accuracy by deciding the amount of influence of each piece of user related data such as data the user enters versus learned data which can contradict information directly input into the system by the user.

Still focusing on the operations represented by block 228, once a system has gathered information about a user it can evaluate that data by preset analytical algorithm and then start to adapt to the user's needs. These adaptations may concern every aspect of the system's behavior and depend on the system's purpose. Information and functions can be presented according to the user's interests, knowledge or goals by displaying only relevant features, hiding information the user does not need, making proposals what to do next and so on. However, it is important to distinguish between adaptive and adaptable systems. In an adaptable system the user can manually change the system's appearance, behavior or functionality by actively selecting the corresponding options. Afterwards the system will stick to these choices. In an adaptive system a dynamic adaptation to the user is automatically performed by the system itself, based on the built user model. Thus, the adaptive system can use different algorithms to interpret information about the user in order to make adaptations for current and or subsequent searches. One way to accomplish this task is implementing rule-based filtering with an artificial intelligence engine.

An AI engine operating in the disclosed environment can establish a set of IF-THEN . . . rules to make decisions, where the IF-conditions can initiate the check for specific user-information and if a match is found the THEN-branch is performed which is responsible for the adaptive changes. Another adaptive approach can be to utilize collaborative filtering in the search process. To achieve such filtering, information about a user can be compared to information of other users of the system. Thus, if characteristics of the current user and user search are similar or match those of another user, the system can make assumptions about the current user by presuming that he or she is likely to have similar search requirements or desires in areas where the subject/current user model is lacking data. Based on these assumptions the AI system can perform adaptive changes.

The system can also utilize adaptive hypermedia. Adaptive hypermedia displays content and offers hyperlinks based on users' specific characteristics, taking their goals, interests, knowledge and abilities into account. Thus, an adaptive hypermedia embodiment can aim to reduce the “lost in hyperspace” syndrome by presenting the user with only highly relevant information. The system can also utilize adaptive educational hypermedia which is a subdivision of adaptive hypeintedia where the main focus of adaptive educational hypermedia is the display of educational content and hyperlinks corresponding to the anticipated or assumed user's knowledge in the particular field in which the user is desiring additional information.

The system can also utilize an intelligent type tutoring system. Different from adaptive educational hypermedia systems, the system operating as an intelligent tutoring system would aim to help students in a specific field of study. For such an embodiment, the system can build user models that store information about a user's ability, knowledge, preferences and needs. The system can then adapt how the specific user is presented with appropriate educational materials and exercises and examples. The system can also offer suggestions and hints and other avenues of assistance that are tailored to what is believed to be or what is most likely tailored to the user's most likely needs.

The system can also implement an expert system type structure. When the system operates as an expert system, system operation emulates the decision-making ability of a human in solving a problem in a specific area. The system can provide sequential or step by step questions to identify why the system is not providing acceptable or less than perfect results to a user in pursuit of finding an acceptable solution. The system can continuously improve user models that are highly adapted to the user's knowledge and experience in a particular field of knowledge by rating or ranking a user on a scale from novice to experts as related to a particular topic. The system can assume, that experienced users are able to receive process and understand more complex materials and answer more complex questions as compared to a user who is young and or new to a topic. The system can adjust the vocabulary and the type of material and questions presented to the user based on this model thereby reducing the time required to create a pleasurable or successful user experience.

There are a number of representational formats and standards utilized for representing users of computer systems which could be utilized by the disclosed system. Such formats and standards include LMS-LIP (IMS—Learner Information Packaging, used in e-learning), HR-XML (used in Human Resource management), JXDM (Justice with the Global Justice Extensible Markup) and Europass (the Europass online CV). Other modeling algorithms that the system can utilize include Personalization routines, cognitive model routines, user profiles modules, and identity management processes.

The above flow charts capture the essence of the invention. The emphasis is on the interactive impartation of education using social media, a repository of knowledge, and group discussions using digital media, fuzzy logic, and artificial intelligence, at the same time, encompassing global educational needs and addressing the cultural gaps. The linguistics will also be addressed using the Ask an Educator feature. A student can choose from educators worldwide; moreover, educators can interact with other educators globally to address the cultural gaps reflected in the various methods of teaching.

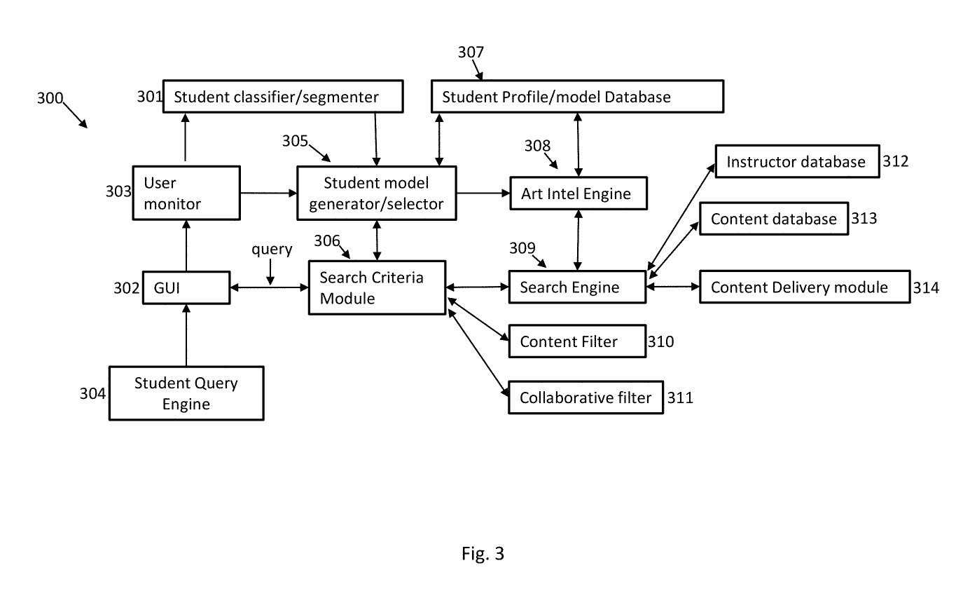

Referring to FIG. 3 a basic software module interactive diagram 300 is depicted. The system can include a graphical use interface (GUI) 302 that the student can utilize to interface with the disclosed system to include providing their user profile, making requests via search engine 309, accessing content and contacting other students and educators. User query engine 304 can assist in helping a student set up their account and in obtaining valuable data about the student. The system via the modules described herein can create a robust user profile such that a student's objectives and goals can be quantified or at least anticipated as will be described in more detail below.

User monitor module 303 can monitor a student's interactions with the system 301, including all searches, clicks, data entered by the student, and all sources of feedback from interactions with the student. User monitor 303 can also automatically and/or upon request, link to one or more of the student's social media accounts to acquire additional information about the user possibly using a web crawler or a spider.

Data acquired about the student based on all the above inputs to include the student's basic interactions with the system via GUI 302 can be utilized by the student classifier/segmenter module 301 to group students by similar characteristics, such that effective student models can be generated by student model generator 305 via interaction with student profile/model database 307. Artificial intelligence module 308 can interact with student model generator 305 to develop tailored student models where such models can be utilized to improve search results that will be returned to the user.

Thus, after a student signs up with the system and has some interaction with the system, the student will likely enter a search query for educational material via GUI 302. The query can be submitted to a front-end search criteria module that can accept the student's search query and can use input from the student model generator/selector 305, and the artificial intelligence module 308, content filter 310 and collaborative filter 311 to build upon or tailor the search query that has been provided by the student. Thus, many weighted variables can be utilized to customize the student's search query such that the search engine 309 can provide improved search results hack to the student via GUI 302.

The search engine 309 using the search criteria provided can query instructor database 312, content database 313 and content delivery modules 314 or sources to return tailored search results to the student. For example, in response to a simple student query on a particular topic the system might return an educator's resume, available lesson plans, media delivery preference, who is determined to be a good candidate to fulfill the student's request, etc.

The novel operation of the educational platform described above can help students, educators, and parents in ways that heretofore were not achievable. The disclosed system bridges gaps caused by various disconnects in language, content and culture across cultures and across the globe across teaching methods and across linguistic boundaries. Students have needs beyond the classroom and need quality and timely solutions to their quest to become educated. The disclosed system provides direct access to qualified and vetted teachers and educators or educational systems whose format and skills best fit the interest of a particular student. The disclosed system also provides interactive sessions with teachers and or qualified educators or educational systems that can better accommodate the particular student's needs based on the student model associated with the particular student. As stated above, there is a clear cultural gap between different students from different parts of the world which has been caused by recent globalization, more intra cultural interactions, increased international trade, and integration of people and cultures generally through communications, technology, and social media.

Given these changes it is now more important than ever to be able to efficiently and effectively impart knowledge to students across communities with minimal costs such that a human is enabled to obtain knowledge irrespective of their financial situation. Further, the disclosed system integrates very important factors about each student to create a holistic teaching environment that puts the student in contact with relevant content, free resources, collaborative projects, interactive sessions with educators, and access to subject specific notes and comments from past students and educators regarding how to get the most from the disclosed system.

The disclosed system also provides educators with a way to stay current with the rapid growth in technologies, current events and globalization via among other things the rise in global workforce distribution and global trade. Further the system allows educators to freely interact with other educators across the world, so that collectively educators can understand the needs of students better, culturally or otherwise. In addition, educators can post and highlight their own educational interests and teaching philosophies and such data can be utilized to better match a student with an educational experience that is better tailored to the students' learning aptitude, learning abilities, and learning process familiarities to provide the most comfortable cultural learning environment. Such a robust educational system can provide educators with the recognition they deserve, and an added sense of respectability, responsibility, and pride. The educational system is interactive on many levels to provide what many educators refer to as “hand holding” by allowing the student to select and interface with nearly every type of educational service currently available.

The disclosed system develops, stores and continually refines a repository of teaching methods and methodology and educational sources whereby students can interact with educators globally, locally, and with other students in similar situations. A student utilizing the system can be empowered by the functions and features available by using the disclosed system for example by joining groups with similar interests and collaborating with students and educators to solve problems and meet the current challenges, all of which can address current educational issues. As a result, students and educators will be more capable of addressing the teaching disparities, cultural gaps and linguistic barriers.

The disclosed system can address a student's needs by putting the student in contact with an educator at any given time, and allowing a way for the student to select choose a qualified educator anywhere across the world who can answer and qualitatively explain concepts on student selected subject matter to thereby empower the student in their quest for knowledge. The disclosed system also provides facilities to put a student in contact with educators and other students who have been brought up with the same cultural background via audio and video interfaces. Such a connection can effectively bridge a cultural gap, such as where a student who might have moved from Japan to the US, that wants a redressal of his/her query, can reach an educator in Japan on a particular topic and learn and understand the concept much quicker and much better.

The repository of notes database and content database can be continually updated and adapted based on user feedback for each subject of technology which leads to a better material for a student to understand certain difficult concepts. Student engagement can be enhanced through interfaces such as messages and notifications from people or entities they associate with. Often a student gets an answer to a question, but the student has no clue as to how the solution was derived. As the student moves on to higher grades, they are handicapped because of lack of qualitative knowledge and the disclosed system can assist in determining if cognitive learning has occurred for each student. The disclosed system provides an educational and learning environment and educational solutions where a student can get a qualitative, interactive, and intra-personal education.

The disclosed system can provide parents of students with a tool to direct, conceptualize, help, and impart the education to their kids. For example, a parent can utilize the repository of notes files, projects files, content database files, group affiliations and search tools to monitor the child and provide feedback into the system.

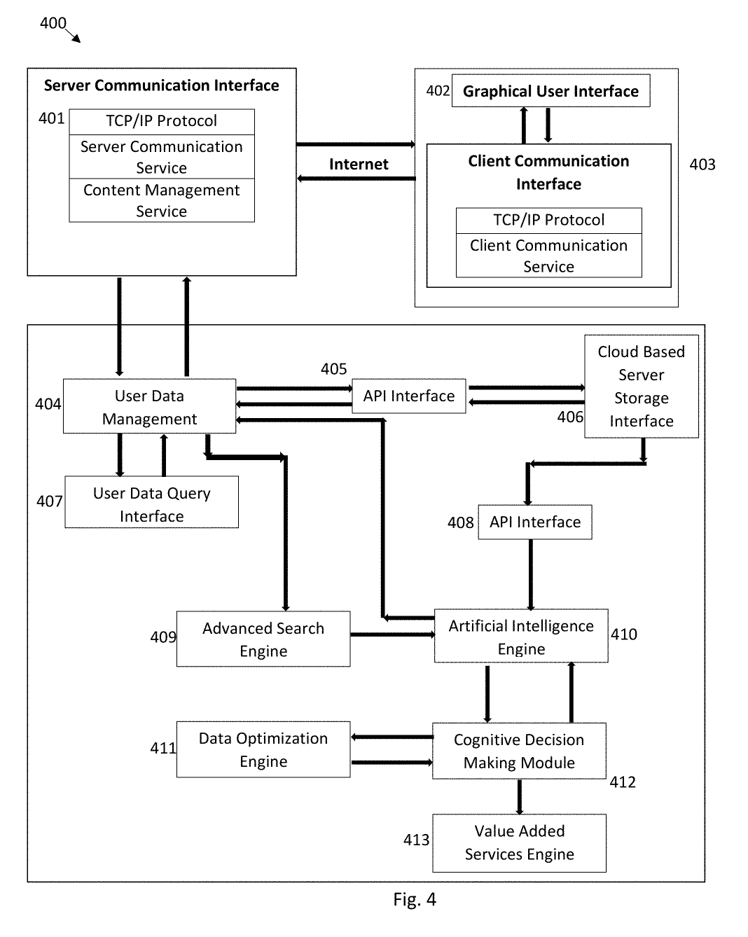

Referring to FIG. 4 a block diagram 400 of operational components of the disclosed system are depicted. A student via graphical user interface 402 can access client communication interface 403 and client communications interface 403 can communicate with a server communication interface 401 using a TCP/IP protocol. Server communication interface 401 can include a server communication service module and a content management service module.

Server communication interface 401 can communicate with user data management module 404 which can communicate with user data query interface module 407. User data query interface can tailor a student's search query based on known attributes and characteristics of the student. User data management module 404 can communicate with cloud-based server storage interface 406 via one or more application programming interfaces (API) 405. Cloud based server storage interface 406 can store information such as student account information, student profile information, educator profiles, educational materials and other data in a database format.

Cloud based Server Storage Interface can supply information about students and their queries to artificial intelligence engine 410 via application programing interfaces (API) 408. Artificial intelligence (AI) engine 410 can also communicate directly with and control the operation of user data management module 404. AI engine 410 can provide input to user data management module 404 which can modify a student's search query based on parameters and attributes known about the student that can be stored in cloud based server storage interface 406.

Artificial intelligence engine 410 can communicate with cognitive decision-making module 41.1 Cognitive decision-making module 412 can communicate with data optimization engine 411 to optimize what search results are returned to the student based on a student's query. Cognitive decision-making module 412 can communicate with value added services engine 413.

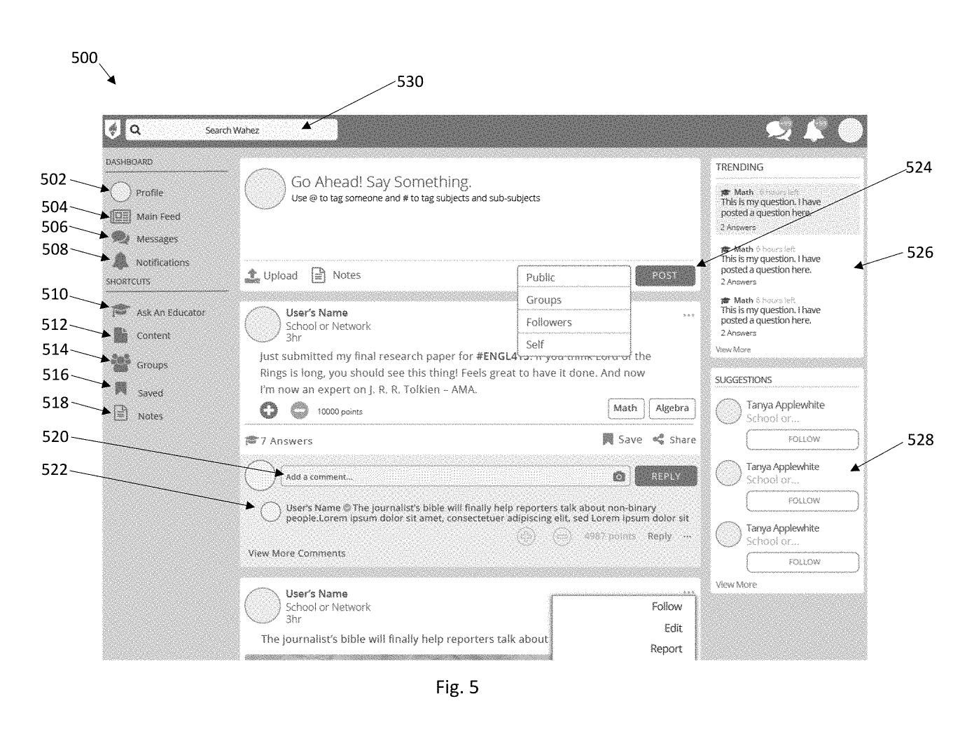

Referring to FIG. 5 a graphical user interface 500 is depicted that can be utilized by a student-user and educators and educational platforms to input profile data and query the system for tailored educational material. In accordance with GUI operation, a student, educator, and educational institution or content provider (i.e. user) can begin entering and uploading data about themselves and build their user profile by clicking on or select profile button 502. The selection of the button 502 and data from pull own menus can be activated utilizing a pointing device such as a mouse, a touch screen, a track ball, or a touchpad. After an initial profile is created, the user can again select the profile button 502 to edit or update their profile. A user profile might contain personal information such as age, sex, education level, place of birth, place currently living, a profile picture, followed users, education achieved, interests and skills to name a few.

When a user selects main feed 504 button, the student can display real time and past activity or posts from other system users. A student user can select messages button 506 to access their private messages inbox and to begin drafting a new message, e-mail or conversation to be sent to others or to reply to an existing message. Selecting notification button 508 allows a user to access and see notifications or posts from others provided to the user via main feed 504. By selecting the notification button 508 the system can display comments from other system users, posts, recent activities and events noted by users and/or any recent activity by groups if groups button 514 has been selected.

By selecting the ask an educator button 510, the system can generate a search for educators based on a user query, user models and user profiles. As stated above a student can add specific data to their profile which can be utilized by the system and method to tailor a student's search for educators and or educational related content. As with most if not all searches provided by the disclosed arrangements, the user can select various filters prior to searching for information such as for educators via the search for educators button 510. One such filter for educators can be filtering by subject matter or topic, location, skill level, native language, and preferred learning mode. In some embodiments after selecting the ask an educator button 510, the system can utilize parameters that are entered into the educator's profile such as known languages, expertise level by subject matter, location and other relevant and important parameters and characteristics found on a typical resume of an expert educator.

A search request utilizing ask an educator button 510 can give a student access to a list of qualified educators based on the query and relevant data in an educator's profile database. The selection of content button 512 can provide a student with access to media content based on student selectable filters such as the topic or subject, the delivery format, i.e. text, video, audio or a combination thereof, pictures and audio. Selection of the content button 512 can also be utilized in some embodiment to share content with other users and in some embodiments, can be utilized to enter comments or blog about how to use the system or how to most efficiently utilize the system, how helpful an educator was, the quality or usefulness of specific educational content, and notes on any aspect of the system or anything relevant to the educational process.

By selecting the groups button 514 the user can review user profiles in a user's list and select users from the list with some common interests to join a group or create a user's group or the groups button 514 can allow a user to join an existing group. Like many selectable buttons after selecting the groups button 514 a user can search for other users with a specific criterion and can also search databases for specific subjects and language from which a group can be formed. Once a group is formed, multiple users with common interests can operate as a social group exchanging comments notes, information, as questions to the group receive answers from group members and share notes and content. When the save button 516 is selected it allows a user to save content display on the displayed page such that it can be viewed later. Selecting the saved button 516 also allows the user to view a list of items saved by the user.

The selection of the notes button 518 by the user allows the student to access notes that have been posted by users. As with most selectable buttons the user can also activate a filter such that notes on a specific topic, from a specific group or from a specific educator only are displayed. By selecting the add comment button 520, a user can respond to a post, notes and/or comments made by another user or it allows the user to add written responses, photos, web site links, notes of other responses via the system.

The selection of comments button 522 allows a user to view and post reactions from student or other users to a post or other comments made by student or other users. A user's post to comments can include attaching media, audio, website links, comments, and written reactions to a post or to a previous comment. A user can also add tags or hashtags to materials and comments via comments button 522 such that the system can notify other users and comments can be better organized and searchable.

Selection of the suggestions list button 528 can display a list of users or educators on the dashboard that might be relevant to a user's website usage history and selection of the suggestions list button 528 can allow a student to access suggested educators, user's content etc., and see their information related to the suggestions such as an educator's profile. Selection of the suggestions list button 528 can also allow a user to start following any educator or student on the list by clicking the “follow” button from a dropdown menu.

The trending column 526 shown on the upper right side of the dashboard can show current activity and/or responses to questions posted and by selecting the “show more” button more responses or input can be displayed from others such as answers to a user's questions. Selection of the post button 524 on the dashboard depicted allows a user to share personal thoughts, notes, and media and to also pose questions to other users. A user can decide who receives their post such as everybody (Public), a particular group (Group) and/or various followers (Follower) and/or just self (User). Other users can reply to a user's post 524 by clicking in the “add a comment” window 520 and type in their comment. Replies to posts can also include tagging and hashtag to refer to another user or topic. A user can click within the search box 530 such that the cursor is in the box and then type in a search query. User searches can be conducted for any type of information such as searching for other users, educators, information or learning content on a specific topic etc.

Each process disclosed herein can be implemented with one or more software programs. The software programs described herein may operate on one or more computers, such as personal computer or a client computer, a server, a virtual server, a cloud platform, a mobile device etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network including wireless communications and cloud computing. Some embodiments include some code and some information being downloaded from the Internet, intranet or other networks. Such signal-bearing media, when carrying computer-readable instnictions that direct the functions of the present disclosure, represent embodiments of the present disclosure.

The disclosed embodiments can be entirely a software embodiment or an embodiment containing both hardware and software elements. In some embodiments, systems and methods disclosed can be implemented in various layers of software, which can include but are not limited to firmware, resident software, microcode, etc. Furthermore, the embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

System components can retrieve instructions from an electronic storage medium or a cloud type system. The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include, compact disk-read only memory (CD-ROM), compact disk read/write (CD-R/W) and digital versatile disk (DVD). A data processing system suitable for storing and/or executing program code can include at least one processor, logic, or a state machine coupled directly or indirectly to memory elements through a system bus. The memory elements can include local memory employed during actual execution of the program code, bulk storage, cache memories, flash based memory, tiered memory etc. where such fast storage provides fast access, temporary storage for data and possibly some program code to reduce the number of times often used data and code must be retrieved from bulk/slower disk based storage.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure, that the disclosure contemplates methods, systems, and media that can provide the above-mentioned features. It is understood that the form of the embodiments shown and described in the detailed description and the drawings are to be taken merely as possible ways to build and utilize the disclosed teachings. It is intended that the following claims be interpreted broadly to embrace all the variations of the example embodiments disclosed.

What is claimed is:

1) A method for delivering educational content comprising:
registering a student by interviewing, collecting and storing information associated with the student's educational history, the information including parameters and variables related to a student's prior cultural educational experiences;
receiving a query from the student for educational content;
generating tailored search criteria for educational materials based on the variables, and parameters associated with the student and the received query;
transmitting the tailored search criteria to a search engine; and
receiving and displaying first search results from the search engine that have a high relevance based on the prior cultural educational experiences of the student.

2) The method of claim 1, further comprising generating a student specific user model based on the user parameters and variables and supplementary information acquired from the user parameters and variables.

3) The method of claim 2, wherein at least one parameter is a student defined search filter.

4) The method of claim 3 wherein the search filter consists of at least one of: content by subject and level search, educator search, people with biographically similar backgrounds search, educators with biographically similar background search, ask an educator, educators for live interactive sessions, with school search, class search, notes, evaluation, and feedback.

5) The method of claim 1, further comprising monitoring the student's interactions with the displayed first search results and determining a student satisfaction metric.

6) The method of claim 5, further comprising learning at least one preference of the student based on the monitoring and generating and associating additional search variables and parameters associated with the student.

7) The method of claim 6, further comprising generating a second search criterion based on the learning, and conducting a second search and displaying second search results.

8) The method of claim 7, further comprising monitoring the student's interaction with the second search results and determining a student's satisfaction related to the displayed second search results and second learning about the student's secondary preferences and storing the secondary preferences as part of a user model associated with the student and proving a third set of search results.

9) A computer program product to facilitate delivering educational content to a student including a computer readable storage medium including instructions that, when executed by a processor cause the processor to:
collect information associated with a student, the information including parameters associated with biographical information associated with the student;
store the collected information;
receive a query input from the student for educational materials, the query having student selectable filters;
generate student centric search criteria for educational related information based on the query input and the collected information by generating weighted search vectors associated with the search query and the collected information;
transmitting the student centric search criteria to a search engine; and
receiving and displaying first search results from the search engine in response to the student centric search query.

10) The computer program product of claim 9, further comprising monitoring user interactions and generating student user models based on the collected information, monitored user interactions and a second query from the student.

11) The computer program product of claim 9, further comprising monitoring the student's interactions and determining a student satisfaction metric.

12) The computer program product of claim 11, further comprising:
learn at least one preference of the student based on the monitoring by an artificial intelligence engine and
integrate the at least one learned preference with the collected information.

13) The computer program product of claim 12, further comprising generate a second search criterion based on the learning, and conduct a second search and displaying second search results.

14) The computer program product of claim 13, further comprising:
monitoring the student's interaction with the second search results;
determine a student's satisfaction related to the displayed second search results;
second learning about the student's secondary preferences and
storing the secondary preferences as part of a user model associated with the student.

15) The computer program product of claim 9, wherein the process to determine further comprises a query to the student to determine the student's satisfaction with an educational experience associated with the product.

16) A method for delivering educational content comprising:
collecting information by a cloud based server that is associated with student's educational history and student behavior based on student-user interaction with a browser;
segmenting and classifying the collected data;
generating a plurality of student-user models by the cloud based server based on the segmented and classified data;
receiving a query from the student;
generating tailored search criteria for educational materials based on the variables, and
parameters associated with the student and the received query;
transmitting the tailored search criteria to a search engine; and
receiving and displaying first search results from the search engine.

17) The method of claim 16, further comprising generating a student specific user model based on the user parameters and variables and supplementary information acquired from the user parameters and variables.

18) The method of claim 17, wherein at least one parameter is a student defined search filter.

19) The method of claim 18, wherein the search filter consists of at least one of: content by subject and level search, educator search, people with biographically similar backgrounds search, educators with biographically similar background search, ask an educator, school search, class search, notes, evaluation, and feedback.

20) The method of claim 16, further comprising monitoring the student's interactions with the displayed first search results and determining a student satisfaction metric.
